(19) United States
(12) Patent Application Publication
(10) Pub. No.: US 2020/0079146 A1
(43) Pub. Date: Mar. 12, 2020

(54) MECANUM WHEEL AND ROBOT HAVING MECANUM WHEEL

(71) Applicant: SZ DJI TECHNOLOGY CO., LTD., Shenzhen (CN)

(72) Inventors: Zhenxu WANG, Shenzhen (CN); Yiqi CHEN, Shenzhen (CN)

(21) Appl. No.: 16/681,247

(22) Filed: Nov. 12, 2019

Related U.S. Application Data
(63) Continuation of application No. PCT/CN2017/086601, filed on May 31, 2017.

(51) Int. Cl. B60B 19/00; B60B 19/12

(52) U.S. Cl. CPC B60B 19/003; B60B 19/125

(57) ABSTRACT

A Mecanum wheel includes a first wheel rim and a second wheel rim disposed opposing the first wheel rim. The Mecanum wheel also includes a first hub coupled to the first wheel rim and a second hub coupled to the second wheel rim. The Mecanum wheel further includes a plurality of rollers disposed between the first wheel rim and the second wheel rim. The second hub is depressed in a direction facing the first hub to form a receiving space configured to receive a motor. The first hub and the second hub are both located on a same side of a middle plane having an equal distance to the first wheel rim and the second wheel rim.

### CROSS-REFERENCE TO RELATED APPLICATION

This application is a continuation application of International Application No. PCT/CN2017/086601, filed on May 31, 2017, the entire content of which is incorporated herein by reference.

### TECHNICAL FIELD

The present disclosure relates to the technology field of omni-directional motion and, more particularly, to a Mecanum wheel and a robot having the Mecanum wheel.

### BACKGROUND

Mecanum wheels are a type of widely used omni-directional wheels. Due to their flexibility of movement and versatility, Mecanum wheels have been widely used in omni-directional, smart movable devices (e.g., robots).

Driving devices (e.g., motors) of Mecanum wheels currently available in the market are disposed outside of the wheel hubs. Extra fasteners may be needed to secure the driving devices to the wheel hubs. However, the external disposition of the driving device is a waste of the space of the wheel hubs. With the driving device disposed external to the wheel hubs, the entire product is not compactly designed. In other words, the volume of the product may be bulky. In addition, the external disposition of the driving device may cause problems such as relatively large mass, inconvenient installation, high cost, and difficulty in the appearance design, etc.

### SUMMARY

In accordance with an aspect of the present disclosure, there is provided a Mecanum wheel that includes a first wheel rim and a second wheel rim disposed opposing the first wheel rim. The Mecanum wheel also includes a first hub coupled to the first wheel rim and a second hub coupled to the second wheel rim. The Mecanum wheel further includes a plurality of rollers disposed between the first wheel rim and the second wheel rim. The second hub is depressed in a direction facing the first hub to form a receiving space configured to receive a motor. The first hub and the second hub are both located on a same side of a middle plane having an equal distance to the first wheel rim and the second wheel rim.

In accordance with another aspect of the present disclosure, there is provided a robot. The robot includes a robot body and a motor connected with the robot body. The robot also includes a Mecanum wheel connected with the robot body and the motor. The Mecanum wheel includes a first wheel rim and a second wheel rim c disposed opposing the first wheel rim. The Mecanum wheel also includes a first hub coupled to the first wheel rim and a second hub coupled to the second wheel rim. The Mecanum wheel further includes a plurality of rollers disposed between the first wheel rim and the second wheel rim. The second hub is depressed in a direction facing the first hub to form a receiving space configured to receive the motor. The first hub and the second hub are both located on a same side of a middle plane having an equal distance to the first wheel rim and the second wheel rim.

According to the technical solutions of the present disclosure, one of two hubs located at both sides of a middle plane (the middle plane having an equal distance to a first wheel rim and a second wheel rim), as used in existing technology, is moved relative to the other one of the hubs. In some embodiments, one of the hubs located at both sides of the middle plane is depressed relative to the other one of the hubs, such that the two hubs are located on a same side of the middle plane. As a result, a receiving space may be formed to receive a motor. Such configurations render the overall structure more compact, and the product more miniature.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a perspective view of a Mecanum wheel, according to an example embodiment.

FIG. 2 is an exploded view of the Mecanum wheel shown in FIG. 1, according to an example embodiment.

FIG. 3 is a perspective view of the Mecanum wheel shown in FIG. 1 from another perspective, according to an example embodiment.

FIG. 4 is a perspective view of the Mecanum wheel shown in FIG. 1 from another perspective, according to an example embodiment.

FIG. 5 is a perspective view of the Mecanum wheel shown in FIG. 1 from another perspective, according to an example embodiment.

FIG. 6 is a perspective view of a Mecanum wheel, according to another example embodiment.

FIG. 7 is a perspective view of a robot, according to an example embodiment.

### LIST OF ELEMENTS

100: Robot body;
200: Mecanum wheel;
300: Motor;
400: Suspension frame;
500: Imaging device;
1: First wheel rim;
11: First supporting member;
111: First connecting member;
112: First reinforcing member;
2: Second wheel rim;
21: Second supporting member;
211: Second connecting member;
212: Second reinforcing member;
3: First hub;
31: First through hole;
32: First inner hub;
33: First outer hub;
34: First spoke;
4: Second hub;
41: Second through hole;
42: Second inner hub;
43: Second outer hub;
44: Second spoke;
5: Roller;
51: Roller shaft;
52: Roller body;
6: Receiving space;
7: Fastener;
8: Lubricating ring;

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, a Mecanum wheel 200 and a robot having the Mecanum wheel 200 will be described in detail with reference to the accompanying drawings. Unless there is obvious conflict, various embodiments and various features included in the embodiments may be combined.

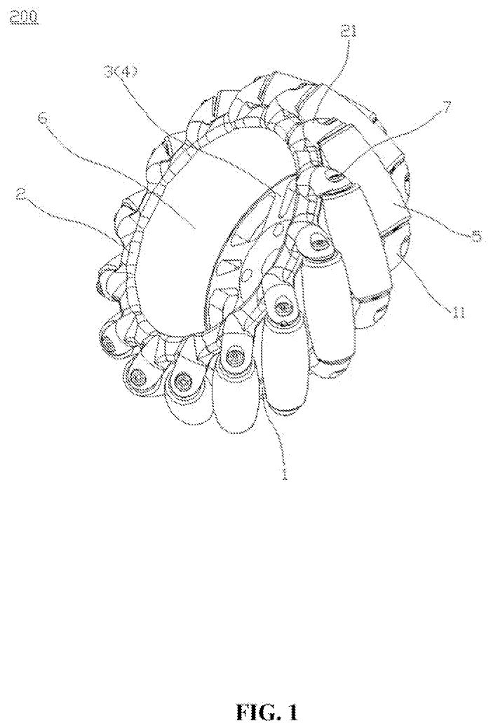

As shown in FIG. 1, the Mecanum wheel 200 may include a first wheel rim 1, a second wheel rim 2 disposed opposite (or opposing) the first wheel rim 1. The Mecanum wheel 200 may also include a plurality of rollers 5 disposed between the first wheel rim 1 and the second wheel rim 2. The first wheel rim 1 may couple to a first hub 3, and the second wheel rim 2 may couple to a second hub 4. The first hub 3 and the second hub 4 may form an integral part to support the first wheel rim 1 and the second wheel rim 2. The second hub 4 may be depressed in a direction facing the first hub 3, which forms a receiving space 6 such that the first hub 3 and the second hub 4 are both located in a same side of a middle plane that has an equal distance to the first wheel rim 1 and the second wheel rim 2. The receiving space 6 may be configured to receive or accommodate a motor 300 (or a driving motor 300).

In some embodiments, the second hub 4 depressing in a direction facing the first hub 3 means that the second hub 4 depresses in the direction facing the first hub 3 to form a groove. The groove is the receiving space 6. In some embodiments, the groove may be located at a middle portion of the second hub 4.

In some embodiments, the second hub 4 depressing in the direction facing the first hub 3 means that the second hub 4 moves as a whole toward the first hub 3 to form the receiving space 6. By changing the mounting position or the formation position of the second hub 4, the receiving space 6 may be formed without changing the structure of the second hub 4. This configuration of realizing the receiving space 6 is relatively simple. In some embodiments, to increase the size of the receiving space 6, the first hub 3 may be designed to be on a same horizontal plane as the first wheel rim 1, and the second hub 4 may be moved, as a whole, toward the first hub 3 as close to the first hub 3 as possible, thereby increasing the size of the receiving space 6.

In some embodiments, the first hub 3 and the second hub 4 may be exchanged. That is, the first hub 3 may depress in a direction facing the second hub 4 to form the receiving space 6, such that the first hub 3 and the second hub 4 are both located at the same side of a middle plane that has an equal distance to the first wheel rim 1 and the second wheel rim 2.

In the present disclosure, one of the two hubs located at both sides of a middle plane (which has an equal distance to the first wheel rim 1 and the second wheel rim 2), as used in existing technologies, may be moved toward the other one of the two hubs, or one of the two hubs located at both sides of the middle plane, as used in existing technologies, may be depressed toward the other one of the two hubs, such that the two hubs are both located at the same side of the middle plane (i.e., the two hubs are biasedly disposed), thereby forming the receiving space for receiving the motor. The disclosed configuration renders the structure more compact, and the product more miniature.

Next, the structure of the Mecanum wheel 200 will be described using the second hub 4 depressing toward the first hub 3 as an example.

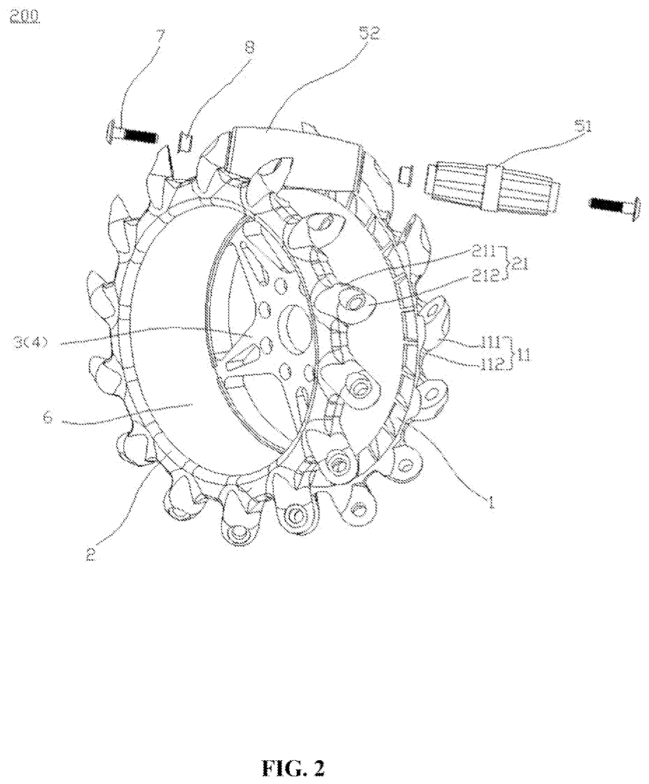

In some embodiments, as shown in FIG. 2, the first wheel rim 1 and the second wheel rim 2 have an identical structure. The first wheel rim 1 and the second wheel rim 2 are connected to form a circular ring structure. The rollers 5 are disposed on an outer ring surface of the circular ring structure. The first hub 3 and the second hub 4 are connected with an inner ring surface of the circular ring structure, thereby supporting the first wheel rim 1 and the second wheel rim 2.

In some embodiments, to further increase the size of the receiving space 6, the first hub 3 and the first wheel rim 1 may be disposed on a same plane, and the second hub 4 and the first hub 3 may be disposed adjacent one another or close to one another (e.g., contacting one another or separating from one another with a small gap). In some embodiments, the plane on which the first hub 3 and the first wheel rim 1 are disposed is a plane that is parallel with a middle plane of the first wheel rim 1 and the second wheel rim 2. In this embodiment, the first hub 3 and the first wheel rim 1 may be disposed on the same plane. Thus, the first hub 3 and the first wheel rim 1 may have a sufficiently large contact area. This configuration enables the first hub 3 to provide a maximum supporting force. In the meantime, in this configuration, the first hub 3 may be disposed as far from the middle plane as possible, thereby increasing a movable distance for the second hub 4. In some embodiments, the second hub 4 and the first hub 3 may be disposed adjacent or close to one another (e.g., contacting one another or separating from one another with a small gap), thereby rendering a relatively large receiving space 6, such that the receiving space 6 may accommodate different types of motor 300.

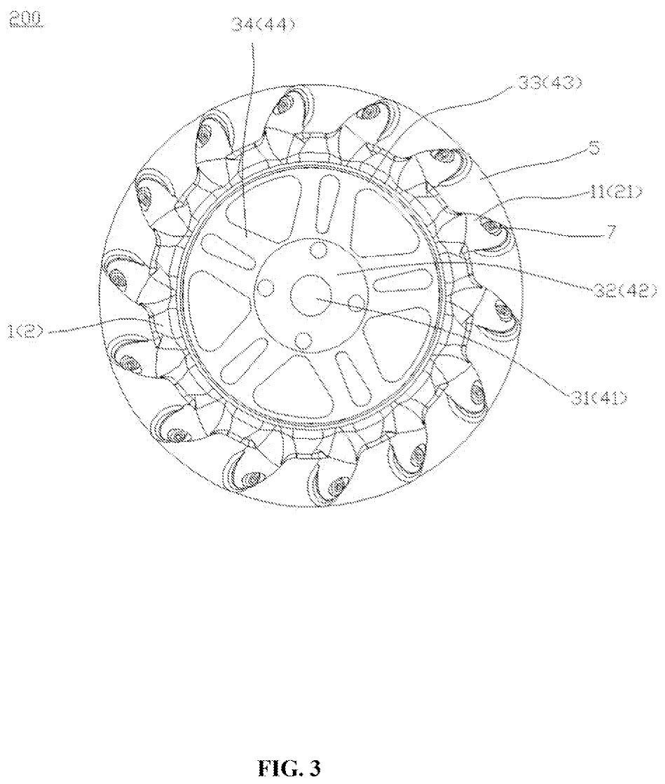

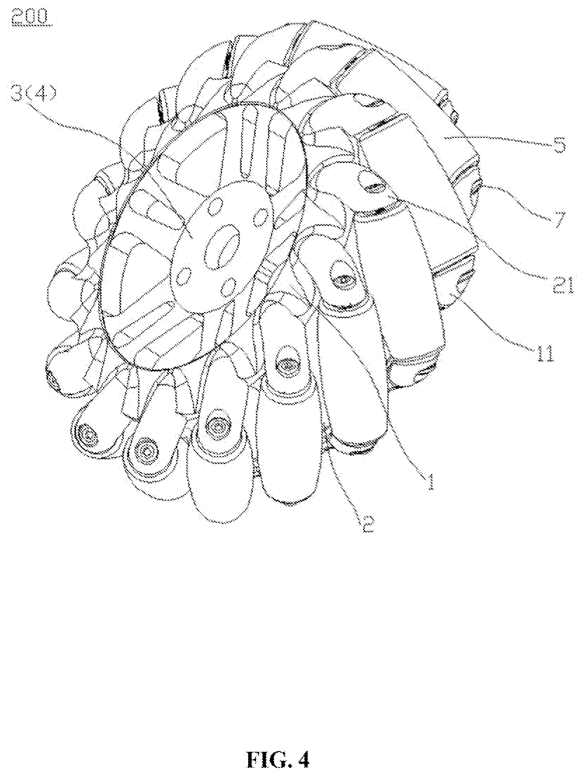

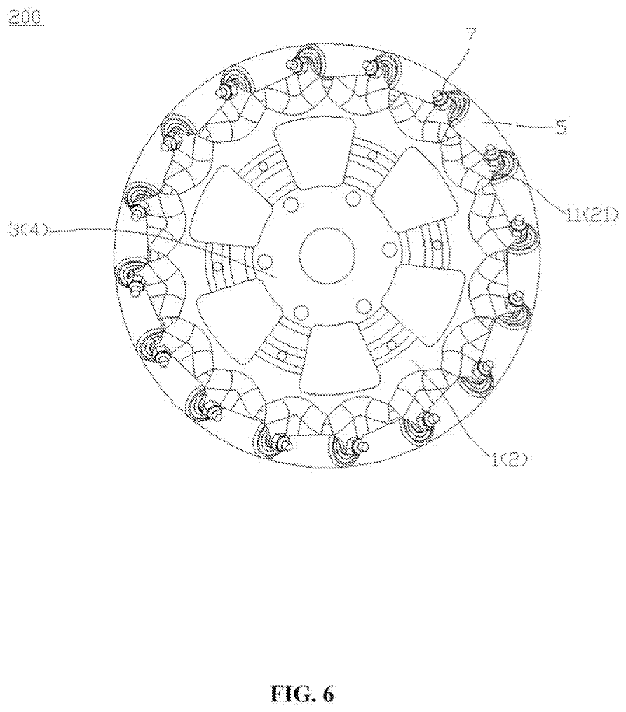

Referring to FIG. 3, FIG. 4, and FIG. 6, the first hub 3 may be provided with a first through hole 31, the second hub 4 may be provided with a second through hole 41. The first through hole 31 and the second through hole 41 may be disposed on a same axis, and may be configured for mounting the motor 300. The motor 300 may be securely mounted to the first hub 3 and the second hub 4 through the first through hole 31 and the second through hole 41. Power provided by the motor 300 may be transmitted to the first hub 3 and the second hub 4. In some embodiments, an output shaft of the motor 300 may be inserted into the first through hole 31 and the second through hole 41.

Referring to FIG. 3, the first hub 3 may include a first inner hub 32, a first outer hub 33, and multiple spokes 34, which may reduce the weight of the first hub 3. The multiple spokes 34 may be provided between the first inner hub 32 and the first outer hub 33. An end of each spoke 34 may be connected with the first inner hub 32, and another end of each spoke 34 may be connected with the outer hub 33, thereby connecting the first inner hub 32 and the second outer hub 43 to form a supporting structure. The second hub 4 may include a second inner hub 42, a second outer hub 43, and multiple spokes 44, which may reduce the weight of the second hub 4. The multiple spokes 44 may be provided between the second inner hub 42 and the second outer hub 43. An end of each spoke 44 may be connected with the second inner hub 42, and another end of each spoke 44 may be connected with the second outer hub 43, thereby connecting the second inner hub 42 and the second outer hub 43 to form a supporting structure.

In some embodiments, the first outer hub 33 and the second outer hub 43 may be connected to the inner ring surface of the circular ring structure, to support the first wheel rim 1 and the second wheel rim 2. The connection method for connecting the first outer hub 33 and the second outer hub 43 with the inner ring surface of the circular ring structure may be configured based on actual needs. In some embodiments, the first outer hub 33 and the second outer hub 43 may be connected with the inner ring surface of the circular ring structure through snap-fitting connection. In some embodiments, the first outer hub 33 and the second outer hub 43 may be connected with the inner ring surface of the circular ring structure through insertion connection. Other connection methods may be used for connecting the first outer hub 33 and the second outer hub 43 with the inner ring surface of the circular ring structure. The present disclosure does not limit the connection method.

To increase the strength of the first hub 3, the widths of both ends of each spoke 34 may be greater than the width at the middle portion. Thus, the connection area between the first spoke 34 and the first inner hub 32, and the connection area between the first spoke 34 and the first outer hub 33 may be increased, which may increase the strength of the first hub 3. Correspondingly, to increase the strength of the second hub 4, the widths of both ends of the second spoke 44 may be greater than the width at the middle portion. Thus, the connection area between the second spoke 44 and the second inner hub 42, and the connection area between the second spoke 44 and the second outer hub 43 may be increased, which may increase the strength of the second hub 4.

Referring to FIG. 2, FIG. 3, and FIG. 4, to further increase the strength of the first hub 3, the multiple spokes 34 may be configured such that two adjacent spokes 34 are disposed as a group. Accordingly, multiple first spoke groups may be formed, each including a pair of first spokes 34. The multiple first spoke groups may be uniformly distributed along radial directions of the first hub 3. Correspondingly, to further increase the strength of the second hub 4, multiple spokes 44 of the second hub 4 may be configured such that two adjacent spokes 44 are disposed as a group. Accordingly, multiple second spoke groups may be formed, each including a pair of second spokes 44. The multiple second spoke groups may be uniformly distributed along radial directions of the second hub 4. In the present disclosure, by arranging the multiple first spokes 34 and the multiple second spokes 44, the first hub 3 and the second hub 4 may satisfy different strength criteria. In some embodiments, the first spoke group may include more than two first spokes 34, and the second spoke group may include more than two second spokes 44. Thus, the first hub 3 and the second hub 4 having different strengths may be designed by configuring the spokes differently.

In some embodiments, the number of the first spokes 34 may be selected based on factors of the first hub 3 such as the strength criterion, the weight criterion, etc. The number of the second spokes 44 may be selected based on factors of the second hub 4 such as the strength criterion, the weight criterion, etc. Referring to FIG. 3 and FIG. 4, in one embodiment, taking the strength and weight into consideration, the number of the first spokes 34 and the second spokes 44 may be 10, respectively. The ten first spokes 34 may form five first spoke groups, each group having a pair of first spokes 34. The five first spoke groups may be uniformly distributed around the center of the first inner hub 32. The ten second spokes 44 may form five second spoke groups, each group having a pair of second spokes 44. The five second spoke groups may be uniformly distributed around the center of the second inner hub 42. By configuring the distribution of the first spokes 34 and the second spokes 44, the first hub 3 and the second hub 4 may satisfy different strength criteria. In other embodiments, the distribution of the first spokes 34 may be selected based on factors associated with the first hub 3, such as the strength criterion and the weight criterion. The distribution of the second spokes 44 may be selected based on factors associated with the second hub 4, such as the strength criterion and the weight criterion.

Referring to FIG. 6, in some embodiments, the first hub 3 and the second hub 4 may both have a solid structure, which may increase the strength and supporting capability of the first hub 3 and the second hub 4, such that the Mecanum wheel 200 may better adapt to harsh environment.

In some embodiments, the first hub 3 and the second hub 4 may be integrally formed as a single piece, which may simplify the structure. In some embodiments, the first hub 3 and the second hub 4 may be two independent components.

Referring to FIG. 1 and FIG. 2, a first supporting member 11 may be provided at an outer edge of the first wheel rim 1, and a second supporting member 21 may be provided at an outer edge of the second wheel rim 2. An end of each roller 5 may connect with the first supporting member 11, and another end of each roller 5 may connect with the second supporting member 21, thereby fixedly connecting the first wheel rim 1 and the second wheel rim 2.

In some embodiments, to increase the stability of the first supporting member 11 and the second supporting member 21, the first supporting member 11 and the first wheel rim 1 may be integrally formed, and the second supporting member 21 and the second wheel rim 2 may be integrally formed.

As shown in FIG. 3, the first supporting member 11 may include a first connecting member 111 and a first reinforcing member 112. The second supporting member 21 may include a second connecting member 211 and a second reinforcing member 212. The first connecting member 111 and the first reinforcing member 112 may be connected. The second connecting member 211 and the second reinforcing member 212 may be connected. The first connecting member 111 and the second connecting member 211 may be disposed opposite one another and may be configured to mount the two ends of a roller 5, respectively, to thereby securing the roller 5 to the outer ring surface of the circular ring structure. In some embodiments, the first reinforcing member 112 may be disposed between the first connecting member 111 and the inner ring surface of the circular ring structure. The second reinforcing member 212 may be disposed between the second connecting member 211 and the inner ring surface of the circular ring structure.

In some embodiments, when the roller 5 moves, a portion of the first supporting member 11 closer to the roller 5 may experience a larger force, and therefore, is more susceptible to damage. Thus, the structure of the first supporting member 11 may be specially designed to render the first supporting member 11 satisfying a motion criterion of the roller 5. In some embodiments, to increase the strength of the first supporting member 111, the first reinforcing member 112 may protrude out from an outer surface of the first wheel rim 1 and may be connected with the outer surface of the first wheel rim 1. In some embodiments, the first reinforcing member 112 of the first supporting member 11 may include a first side (not labeled in figures) and a second side (not labeled in figures) opposing the first side. The first side may be connected with the first connecting member 111. In some embodiments, to increase the strength of the first reinforcing member 112, a width of the first reinforcing member 112 may gradually decrease from the first side to the second side. In some embodiments, to increase the strength of the first reinforcing member 112, a height of the first reinforcing member 112 may gradually decrease from the first side to the second side.

In some embodiments, for the convenience of connecting the roller 5, the first connecting member 111 may protrude from the first wheel rim 1. For example, an end of the first connecting member 111 may connect with a corresponding reinforcing member 112, and another end of the first connecting member 111 may connect with the roller 5. In some embodiments, to increase the strength of the first connecting member 111, the width and/or height of the first connecting member 111 may gradually decrease from the end connecting with the roller 5 to the other end connecting the corresponding first reinforcing member 112.

In some embodiments, when the roller 5 moves, a portion of the second supporting member 21 closer to the roller 5 may experience a larger force, and therefore, may be susceptible to damage. Thus, the structure of the second supporting member 21 may be designed such that the strength of the second supporting member 21 satisfies a motion criterion of the roller 5. In some embodiments, to further increase the strength of the second supporting member 21, the second reinforcing member 212 may protrude from an outer surface of the second wheel rim 2 and may be connected with the outer surface of the second wheel rim 2. In some embodiments, the second reinforcing member 212 may include a third side (not labeled in figures) and a fourth side (not labeled in figures) opposite the third side. The third side may connect a corresponding second connecting member 211. In some embodiments, to increase the strength of the second reinforcing member 212, the width of the second reinforcing member 212 may gradually decrease from the third side to the fourth side. In some embodiments, to increase the strength of the second reinforcing member 212, the height of the second reinforcing member 212 may gradually decrease from the third side to the fourth side.

In some embodiments, for the convenience of connecting the roller 5, the second connecting member 211 may protrude from the second wheel rim 2. In some embodiments, an end of the second connecting member 211 may connect a corresponding second reinforcing member 212 and another end of the second connecting member 211 may connect the roller 5. In some embodiments, to increase the strength of the first connecting member 111, the width and/or height of the second connecting member 211 may gradually decrease from the end connecting the roller 5 to the other end connecting the corresponding second reinforcing member 212.

In some embodiments, the first connecting member 111 and the first reinforcing member 112 may be integrally formed. The structure is relatively simple, and the strength of the first supporting member 11 may be increased. In some embodiments, the second connecting member 211 and the second reinforcing member 212 may be integrally formed. The structure is relatively simple, and the strength of the second supporting member 21 may be increased.

In some embodiments, the first connecting member 111 and the corresponding first reinforcing member 112 may be integrally formed. The second connecting member 211 and the corresponding second reinforcing member 212 may be integrally formed. The strength of the first supporting member 11 and the second supporting member 21 may be optimized and the appearance of the first supporting member 11 and the second supporting member 21 may be designed by considering the force or stress related characteristics of the first supporting member 11 and the second supporting member 21, such that the strength of the first supporting member 11 and the second supporting member 21 may be increased, and the appearance of the first supporting member 11 and the second supporting member 21 may become more aesthetically attractive.

In some embodiments, the first supporting member 11 and the second supporting member 21 may be disposed along the circumference of the Mecanum wheel 200 at staggered locations offset by a predetermined angle, such that the rollers 5 disposed between the first supporting member 11 and the corresponding second supporting member 21 are obliquely disposed, which may increase the flexibility and versatility of the motion of the rollers 5. In some embodiments, the predetermined angle may be 15°, 30°, 45°, etc.

In some embodiments, the first supporting member 11 and the second supporting member 21 may be disposed in pairs. Each pair of the first supporting member 11 and the second supporting member 21 may be connected with the two ends of each roller 5 to secure the roller 5. The number of the pairs of the first supporting member 11 and the second supporting member 21 may be set based on the motion needs. Based on the motion needs, a corresponding number of rollers 5 may be connected to realize the flexibility and versatility of the motion of the roller 5.

In some embodiments, the material used for making the first wheel rim 1, the second wheel rim 2, the first hub 3, and the second hub 4 may be selected based on the manufacturing process, price, strength, weight, and other factors. For example, the material for making the first wheel rim 1, the second wheel rim 2, the first hub 3, and the second hub 4 may be steel, alloy, or carbon fibers, or any other suitable materials. The present disclosure does not limit the material for making the first wheel rim 1, the second wheel rim 2, the first hub 3, and the second hub 4. The material for making the first supporting member 11 and the second supporting member 21 may be selected based on the manufacturing process, price, strength, weight, and other suitable factors. For example, the material for making the first supporting member 11 and the second supporting member 21 may be steel, alloy, or carbon fiber, or other suitable materials.

In some embodiments, to have a desired mechanical strength for the first wheel rim 1, the first hub 3, and the first supporting member 11, a desired mechanical strength of the second wheel rim 2, the second hub 4, and the second supporting member 21, and to reduce the weight of the Mecanum wheel 200, such that the operational noise of the Mecanum wheel 200 may be reduced during operation, when manufacturing the Mecanum wheel 200, firstly, the first wheel rim 1, the first hub 3, the second wheel rim 2, and the second hub 4 may be formed by molding with a carbon fiber. Then, an outer edge of the first wheel rim 1 may be cut to form the first connecting member 111 and the first reinforcing member 112 of the first supporting member 11, and an outer edge of the second wheel rim 2 may be cut to form the second connecting member 211 and the second reinforcing member 212 of the second supporting member 21.

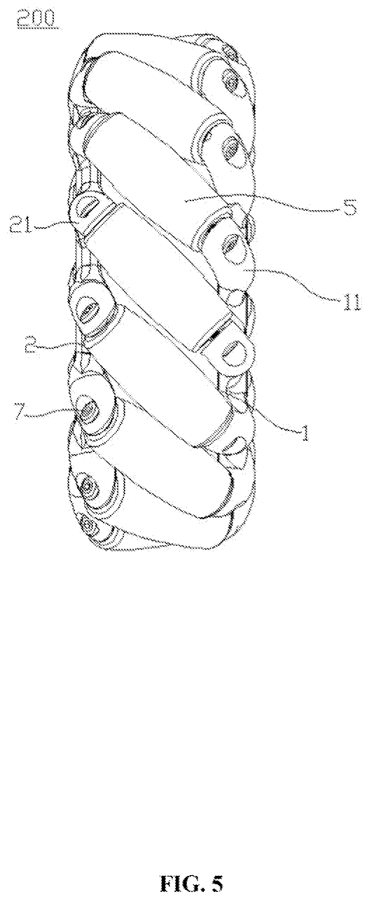

In some embodiments, as shown in FIG. 1 to FIG. 6, the Mecanum wheel 200 may include a fastener 7. The fastener 7 may be disposed to penetrate through the first connecting member 111 and the second connecting member 211 to securely mount two sides of the roller 5. In some embodiments, for each pair of the first supporting member 11 and the second supporting member 21, the first connecting member 111 and the second connecting member 211 may be provided with one or more through holes, respectively. In some embodiments, two fasteners 7 may be provided, each fastener 7 may penetrate through the corresponding through hole(s) to connect with the roller 5, thereby securely fixing the roller 5 between the first supporting member 11 and the second supporting member 21. The present disclosure fixes the two ends of the roller 5 through the fasteners 7, which replaces a conventional fixing method that uses a bolt penetrating through the roller 5. The disclosed securing method is simpler and has a stronger stability.

In some embodiments, the fastener 7 may include at least one of a screw, a nut, or any other suitable fastener, such as a pin.

Referring to FIG. 3, the Mecanum wheel 200 may include a lubricating ring 8 configured to couple with the fastener 7. The fastener 7 may be sleeve-fit with the lubricating ring 8, and may penetrate through the corresponding through hole to connect with the roller 5. By providing the lubricating ring 8 to secure the fastener 7, when the roller 5 moves, the fastener 7 may not become loose. In addition, the lubricating ring 8 may seal the connection between the corresponding fastener 7 and the roller 5 to restrain the external dust or other obstacle from entering the interior of the corresponding roller 5, which may impede the movement of the roller 5.

Still referring to FIG. 3, the roller 5 may include a roller shaft 51 and a roller body 52 configured to rotatably sleeve-fit onto the roller shaft 51. For the convenience of securing the roller 5, two ends of the roller shaft 51 may be exposed from the roller body 52. The fastener 7 may connect with the two ends of the roller shaft 51.

In some embodiments, the roller body 52 may have an integrally formed structure, and may have a substantial drum shape. The roller body 52 may include a through hole in the axial direction for the roller shaft 51 to penetrate through. In some embodiments, an outer surface of the roller body 52 may be a smooth surface. In some embodiments, the outer surface of the roller body 52 may be provided with treads to increase the friction force of the roller 5 contacting the ground or floor. In some embodiments, the treads may have various shapes or patterns, such as line shape, point shape, or protrusions and/or depressions of various patterns.

In some embodiments, the material for the roller shaft 51 and the roller body 52 may be set based on actual needs. In some embodiments, to support the roller body 52 better, the strength of the roller shaft 51 may be greater than the strength of the roller body 52. In some embodiments, the roller body 52 may be made of a rubber material or any other suitable material, such as plastics. In some embodiments, the roller shaft 51 may be made of steel or alloy.

In some embodiments, the Mecanum wheel 200 may be mounted in a robot or other devices. Next, the application of the Mecanum wheel 200 in a robot will be explained in detail.

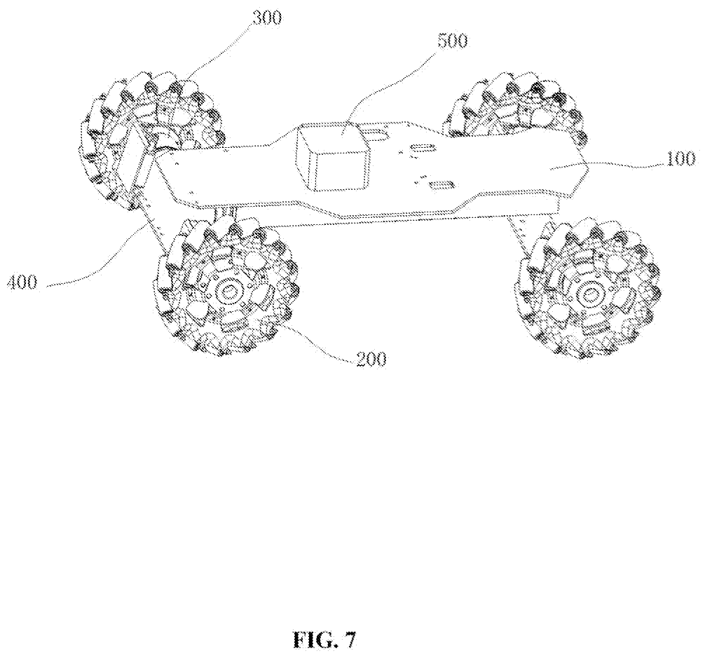

Referring to FIG. 7, the present disclosure provides a robot. The robot may include a robot body 100, a motor 300 configured to provide a driving force, and the above-described Mecanum wheel 200. The Mecanum wheel 200 may be connected with the robot body 100 to provide a driving force for the movement of the robot body 100. The motor 300 may be received or accommodated in the receiving space 6 of the Mecanum wheel 200, such that the structure of the robot is more compact, and the robot is more miniature. In some embodiments, the motor 300 may be replaced with other driving devices.

In some embodiments, the robot may include a suspension 400. The Mecanum 200 may be connected with the robot body 100 through the suspension 400. The suspension 400 may be received in the receiving space 6, such that the structure of the robot is more compact and the robot is more miniature.

In some embodiments, the robot may include a control device (not shown in figures) mounted to the robot body 100. The control device may be configured to control the Mecanum wheel 200 to move according to control commands, such that the robot body 100 moves following a specified path. The control device may be communicatively connected with a remote controller configured to remotely control the movement of the robot. The control device may generate a control command based on a user command transmitted by the remote controller, and may transmit the control command to the motor 300, to control the movement of the Mecanum wheel 200.

In some embodiments, the robot may be an imaging or photographing robot. The imaging robot may include an imaging device 500 provided on the robot body 100 to realize various photographing functions.

In some embodiments, the robot may be a floor cleaning robot.

In some embodiments, the shape of the robot body 100 may be any suitable shape, such as a human shape or a vehicle shape. The detailed shape may be set based on actual needs.

It should be understood that in the present disclosure, relational terms such as “first” and “second,” etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

The above describes the various embodiments of the disclosed Mecanum wheel and the robot having the Mecanum wheel. Various examples are used to explain the principle and implementation methods of the present disclosure. The descriptions of the examples and embodiments are only for the purpose of assisting a person having ordinary skills in the art in understanding the methods and the key concepts of the present disclosure. A person having ordinary skills in the art may modify the detailed implementation methods and application scopes based on the concept of the present disclosure. Such modifications still fall within the scope of the present disclosure. The content of this specification should not be interpreted as limiting the scope of the present disclosure.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A Mecanum wheel, comprising:
a first wheel rim;
a second wheel rim disposed opposing the first wheel rim;
a first hub coupled to the first wheel rim;
a second hub coupled to the second wheel rim; and
a plurality of rollers disposed between the first wheel rim and the second wheel rim,
wherein the second hub is depressed in a direction facing the first hub to form a receiving space configured to receive a motor, and
wherein the first hub and the second hub are both located on a same side of a middle plane having an equal distance to the first wheel rim and the second wheel rim.

2. The Mecanum wheel of claim 1, wherein the first hub and the first wheel rim are disposed on a same plane, and the second hub and the first hub are disposed adjacent one another.

3. The Mecanum wheel of claim 1, wherein the first hub and the second hub each have a through hole configured to mount the motor, the two through holes being disposed on a same axis.

4. The Mecanum wheel of claim 3, wherein the first hub and the second hub are integrally formed.

5. The Mecanum wheel of claim 1,
wherein each of the first hub and the second hub includes an inner hub, an outer hub, and multiple spokes disposed between the inner hub and the outer hub, and
wherein an end of each spoke is connected with a corresponding inner hub, and another end of each spoke is connected with a corresponding outer hub.

6. The Mecanum wheel of claim 5, wherein widths at both ends of each spoke are greater than a width at a middle portion of each spoke.

7. The Mecanum wheel of claim 5,
wherein the multiple spokes of the first hub are disposed in multiple first spoke groups, each of the first spoke groups having a pair of spokes, and the multiple first spoke groups are uniformly distributed along radial directions of the first hub, and
wherein the multiple spokes of the second hub are disposed in multiple second spoke groups, each of the second spoke groups having a pair of spokes, and the multiple second spoke groups are uniformly distributed along radial directions of the second hub.

8. The Mecanum wheel of claim 1,
wherein a first supporting member is disposed at an outer edge of the first wheel rim,
wherein a second supporting member is disposed at an outer edge of the second wheel rim,
wherein an end of each roller is connected with the first supporting member, and another end of the roller is connected with the second supporting member.

9. The Mecanum wheel of claim 8, wherein the first supporting member and the second supporting member are disposed along a circumference of the Mecanum wheel at staggered locations offset by a predetermined angle.

10. The Mecanum wheel of claim 8, wherein the first supporting member and the first wheel rim are integrally formed, and the second supporting member and the second wheel rim are integrally formed.

11. The Mecanum wheel of claim 8, wherein the first supporting member and the second supporting member each include a connecting member configured to mount a roller and a reinforcing member connected with the connecting member.

12. The Mecanum wheel of claim 11,
wherein the reinforcing member of the first supporting member is connected with the first wheel rim and protrudes from an outer surface of the first wheel rim, and
wherein the reinforcing member of the second supporting member is connected with the second wheel rim and protrudes from an outer surface of the second wheel rim.

13. The Mecanum wheel of claim 12,
wherein the reinforcing member of the first supporting member comprises a first side and a second side opposing the first side, the first side being connected with the corresponding connecting member of the first supporting member, and a width of the reinforcing member of the first supporting member gradually decreasing from the first side to the second side,
wherein the reinforcing member of the second supporting member comprises a third side and a fourth side opposing the third side, the third side being connected with the corresponding connecting member of the second supporting member, and a width of the reinforcing member of the second supporting member gradually decreasing from the third side to the fourth side.

14. The Mecanum wheel of claim 12,
wherein the reinforcing member of the first supporting member comprises a first side and a second side opposing the first side, the first side being connected with the corresponding connecting member of the first supporting member, and a height of the reinforcing member of the first supporting member gradually decreasing from the first side to the second side,
wherein the reinforcing member of the second supporting member comprises a third side and a fourth side opposing the third side, the third side being connected with the corresponding connecting member of the second supporting member, and a height of the reinforcing member of the second supporting member gradually decreasing from the third side to the fourth side.

15. The Mecanum wheel of claim 11, wherein the connecting member and the reinforcing member are integrally formed.

16. The Mecanum wheel of claim 11, further comprising at least one fastener configured to penetrate through the connecting member of the first supporting member and the connecting member of the second supporting member to securely mount both ends of a roller.

17. The Mecanum wheel of claim 16, wherein the connecting member of the first supporting member and the connecting member of the second supporting member each comprise a through hole, and
wherein the at least one fastener comprises two fasteners, each fastener configured to penetrate through a corresponding through hole to connect with the roller.

18. The Mecanum wheel of claim 16, further comprising a lubricating ring configured to couple with a corresponding fastener, the corresponding fastener configured to sleeve-fit with the lubricating ring and to penetrate a corresponding through hole to connect with the roller.

19. The Mecanum wheel of claim 16,
wherein the roller comprises a roller shaft and a roller body rotatably sleeve-fit onto the roller shaft, two ends of the roller shaft being exposed from the roller body, and
wherein the at least one fastener is connected with the two ends of the roller shaft.

20. A robot, comprising:
a robot body;
a motor connected with the robot body; and
a Mecanum wheel connected with the robot body and the motor, comprising:
a first wheel rim;
a second wheel rim disposed opposing the first wheel rim;
a first hub coupled to the first wheel rim;
a second hub coupled to the second wheel rim; and
a plurality of rollers disposed between the first wheel rim and the second wheel rim,
wherein the second hub is depressed in a direction facing the first hub to form a receiving space configured to receive the motor, and
wherein the first hub and the second hub are both located on a same side of a middle plane having an equal distance to the first wheel rim and the second wheel rim.
